(19) United States
(12) Patent Application Publication
(10) Pub. No.: US 2026/0310229 A1
(43) Pub. Date: Oct. 8, 2026

(54) AUTONOMOUS MOBILE ROBOT

(71) Applicant: Eureka System S.r.l., Villorba (IT)

(72) Inventor: Eros CONTO', Paese (IT)

(21) Appl. No.: 19/473,929

(22) PCT Filed: Jan. 23, 2024
(86) PCT No.: PCT/EP2024/051500

§ 371 Date: Oct. 9, 2025

(30) Foreign Application Priority Data
Apr. 14, 2023 (IT) 102023000007173

(51) Int. Cl. G05D 1/661; B60L 53/36; G05D 1/24

(52) U.S. Cl. CPC G05D 1/661; B60L 53/36; G05D 1/24

(57) ABSTRACT

An autonomous mobile robot is mechanically connectable to a docking station or to a trolley provided with electrical apparatuses. The robot includes two arms, which can be moved mutually apart on a horizontal plane and can swing on a vertical plane for accessibility to a battery, on which there are conical recesses provided with elements adapted to affect pins/connectors that protrude from a bottom. A base of the docking station or trolley is equipped with electrical apparatuses and is also adapted to transmit electric power to the trolley or to receive electric power from the docking station.

The present invention relates to an autonomous mobile robot that can be mechanically connected to apparatuses provided with an electric power storage system or to a trolley.

Robots, also called “AMRs” or “Autonomous Mobile Robots,” are currently known which are used for the movement of various products and/or semi-finished products in industrial settings.

AMRs of the known type are provided with wheels controlled by navigation systems which, by means of preset maps and adapted software, allow for example the end-of-line handling of various products.

They have excellent positioning capability and high precision and speed of movement, which allow them to move safely and quickly in production environments.

Thus, AMRs are known which are capable of towing a load or trolley that is automatically coupled to them, creating an articulated system.

AMRs are also known which are placed underneath a trolley and are coupled to it by using, for the connection, actuators with self-centering conical pins that protrude upward, entering adapted holes provided in the bottom of the trolley.

An AMR comprises a battery, which is subject to discharge and must be recharged.

The charging of an AMR is usually constituted by a fixed part, also known as charging station or charging docking station (F), and a movable part (M), known as contact pad, which is mounted on board the AMR.

Docking stations (F) of the known type have two articulated and magnetized contacts that are magnetically attracted by two slides, provided with adapted contacts, which are present on the body of the docking station, said body being placed on the ground or wall and connected to the charging power supply located close nearby.

Several drawbacks are however observed: the approach between the contact pad (M) and the charging station (F) to the magnetic attraction point needs to be achieved with millimeter-grade accuracy so that the contacts are in axial alignment with the slides.

This degree of accuracy for an AMR of the known type is very difficult to achieve, except at great cost.

Secondly, the slide contacts of the charging station body placed on the ground are subject to dirt, impact, and trampling, whereas if they are placed on a wall, said wall is not always available or present.

As regards the solution of a trolley coupled and towed by the AMR tractor, its purpose is therefore the transport of goods, and the trolley can be equipped according to the application requirement in passive to active modes; in the former case, one speaks of a crate, shelf, tray, rack, and generic container configuration.

As regards the active mode, one speaks of a configuration with a roller or motorized conveyor belt, lifting systems with electrically actuated jacks, assembly benches provided with electrically powered tools, human-machine interface displays, interconnected via WiFi or BT, drawer cabinets with drawers provided with electric locks.

In the background art, the electronic systems on board active trolleys are powered by means of a buffer battery that is subject to discharge over time and therefore must be recharged, usually by means of a cable provided with a plug that must be inserted manually into an adapted outlet located on an adapted charging base.

This is a drawback, since the charging level of the battery must be monitored, and if said battery is charged, if it is not disconnected from the outlet the trolley is locked and the AMR cannot move it.

Optionally providing the trolley with a contact pad similar to the one of the AMR, previously discussed, would introduce additional complications and problems already described earlier.

Therefore, the aim of the present application is to solve the described technical problems, eliminating the drawbacks of the cited background art, thus devising an autonomous mobile robot that allows both to power a trolley and to be powered by a docking station quickly and easily.

Within this aim, an object of the invention is to provide an autonomous mobile robot that combines the previous characteristics with that of allowing it to be optimally powered regardless of whether there is dirt on the ground and preventing the possibility of any impacts or trampling.

Another object is to obtain an autonomous mobile robot that combines the previous characteristics with that of operating while docked to a trolley even regardless of the state of charge of the electronic systems on board the latter.

Not least object is to obtain an autonomous mobile robot that is structurally simple, has low provision costs, and can be manufactured with the usual known equipment.

This aim and these objects, as well as others that will better apparent hereinafter, are achieved by an autonomous mobile robot mechanically connectable to a docking station, or to a trolley provided with electrical apparatuses, characterized in that it comprises two arms, which can be moved mutually apart on a horizontal plane and can swing on a vertical plane for accessibility to a battery, on which there are conical recesses provided with means adapted to affect said pins/connectors that protrude from the bottom and the base of said overlying docking station or trolley equipped with electrical apparatuses and are adapted to transmit electric power to said trolley or to receive electric power from said docking station.

Further characteristics and advantages of the invention will become better apparent from the detailed description of a particular but not exclusive embodiment, illustrated by way of non-limiting example in the accompanying drawings, wherein:

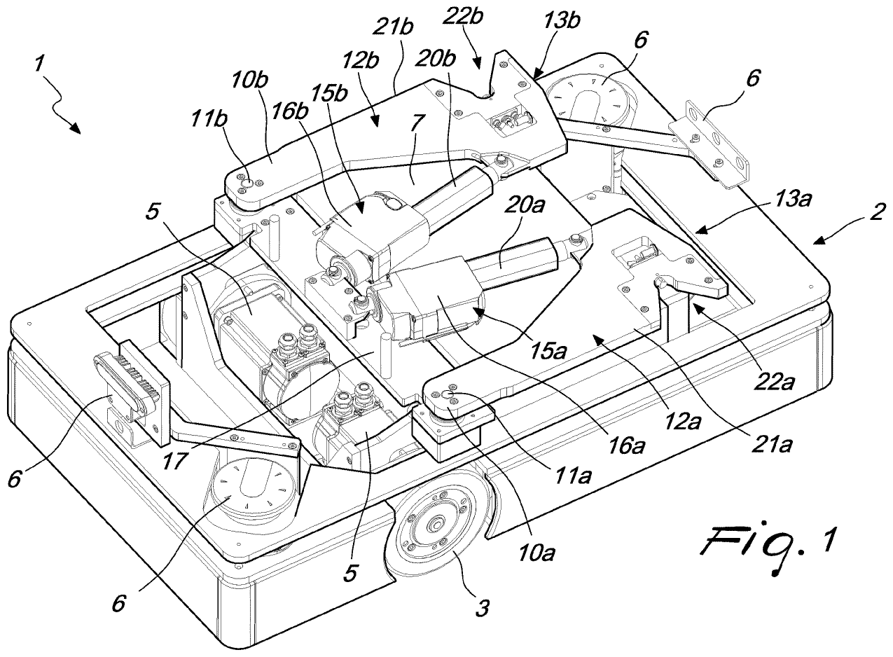

FIG. 1 is a view of the mobile robot in which the cover has been removed;

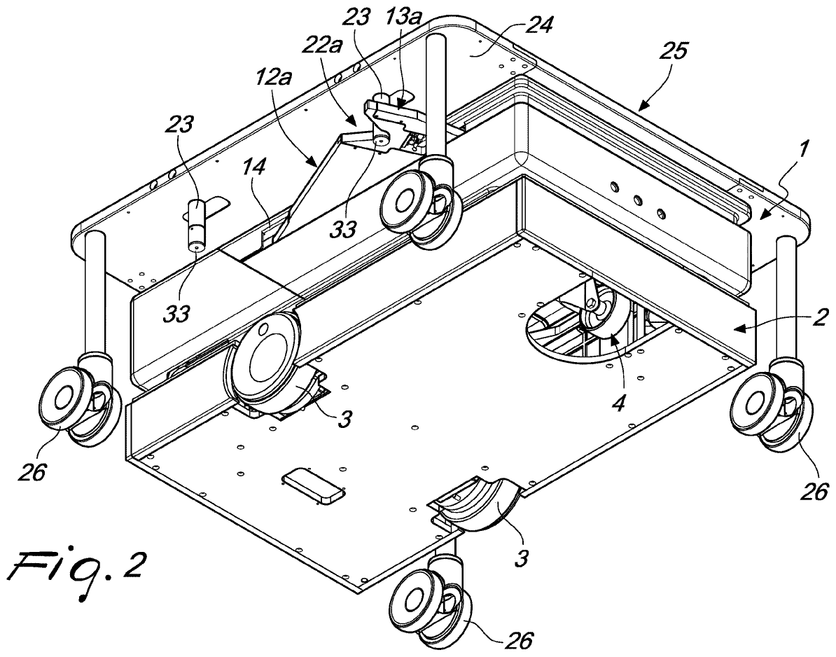

FIG. 2 is a lateral perspective view from below of the mobile robot in the condition of coupling to a trolley;

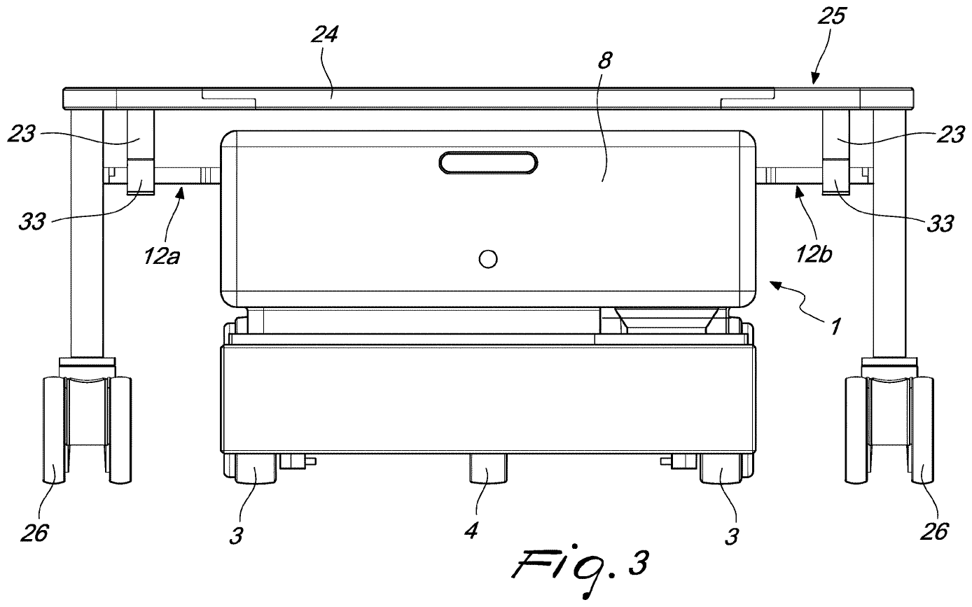

FIG. 3 is a front view of the mobile robot with a trolley attached;

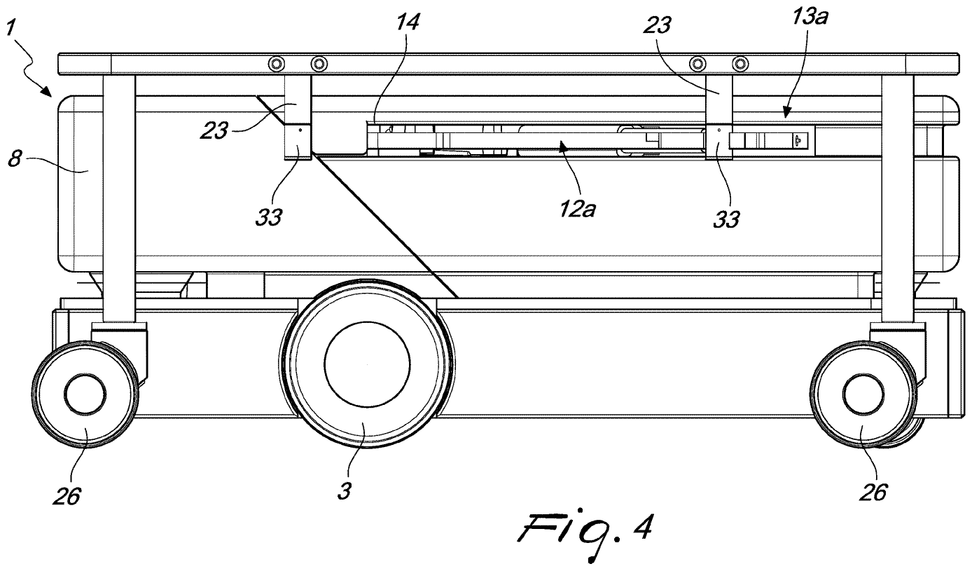

FIG. 4 is a side view of the mobile robot with a trolley attached;

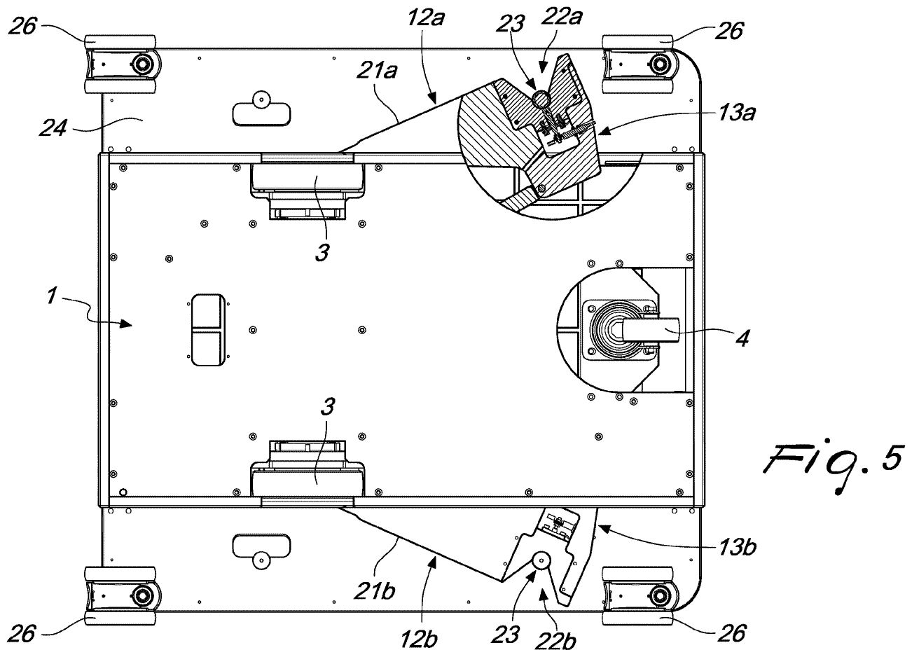

FIG. 5 is a bottom view of the mobile robot with a trolley attached, in partial cross-section at the ends of the arms;

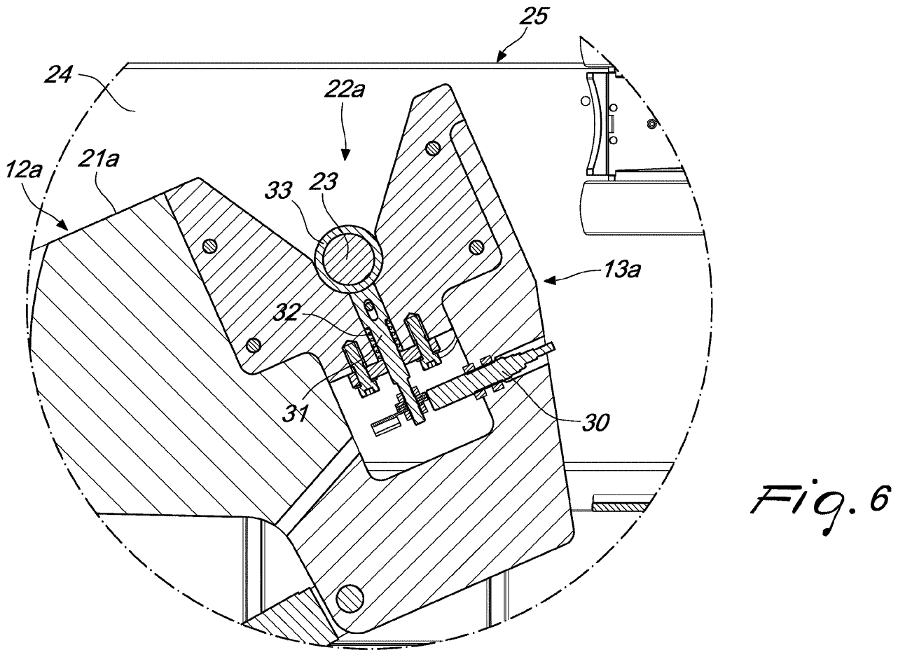

FIG. 6 is a sectional view of one end of an arm;

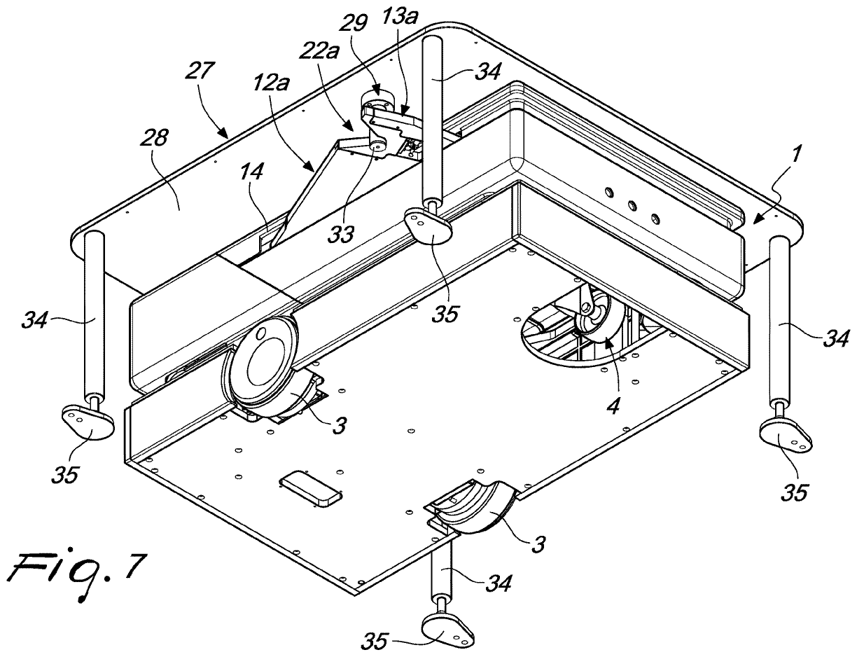

FIG. 7 is a lateral perspective view from below of the mobile robot in the condition in which it is coupled to a docking station;

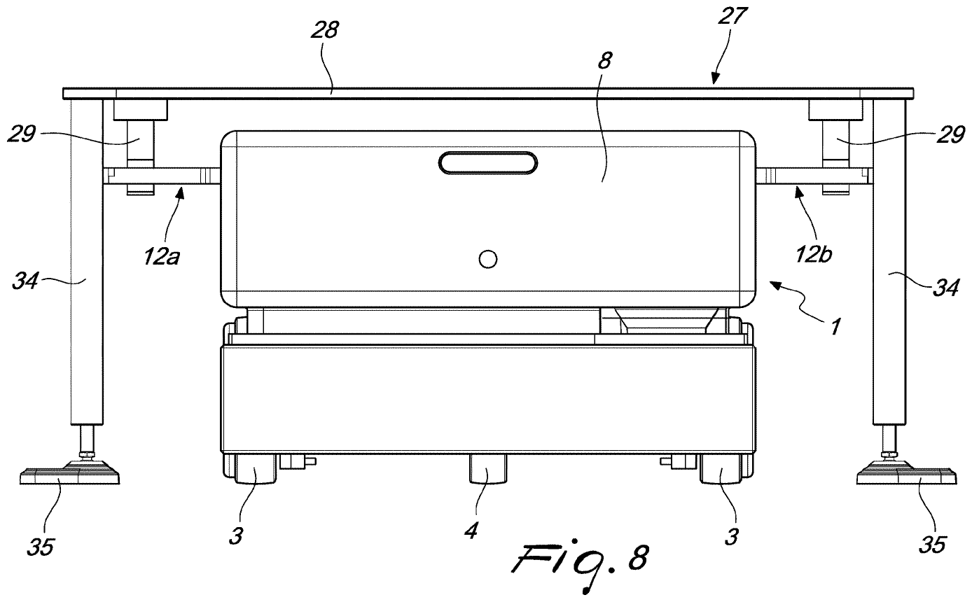

FIG. 8 is a front view of the mobile robot in the condition in which it is coupled to a docking station;

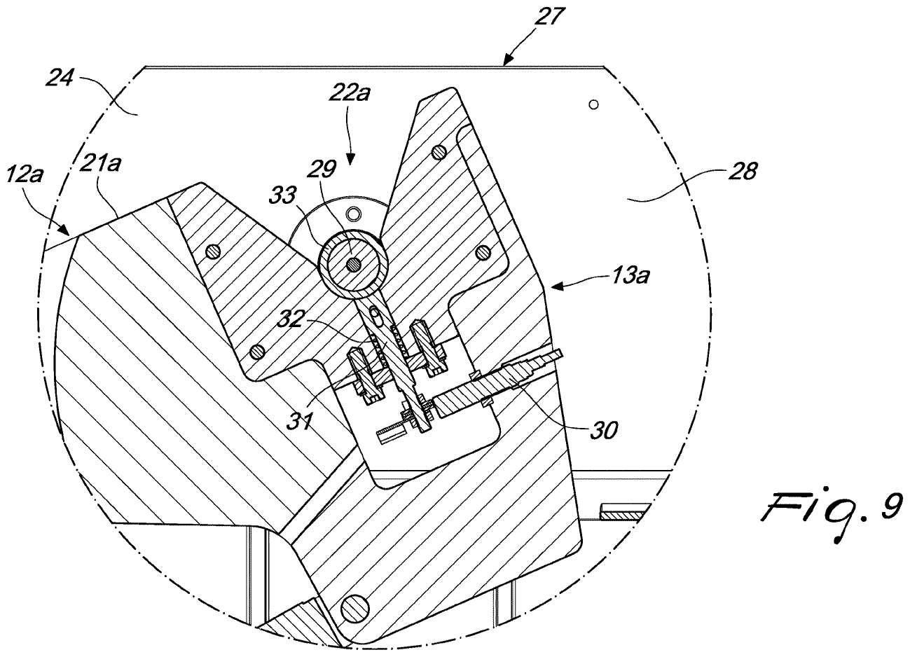

FIG. 9 is a sectional view of one end of an arm according to the configuration of the preceding figure;

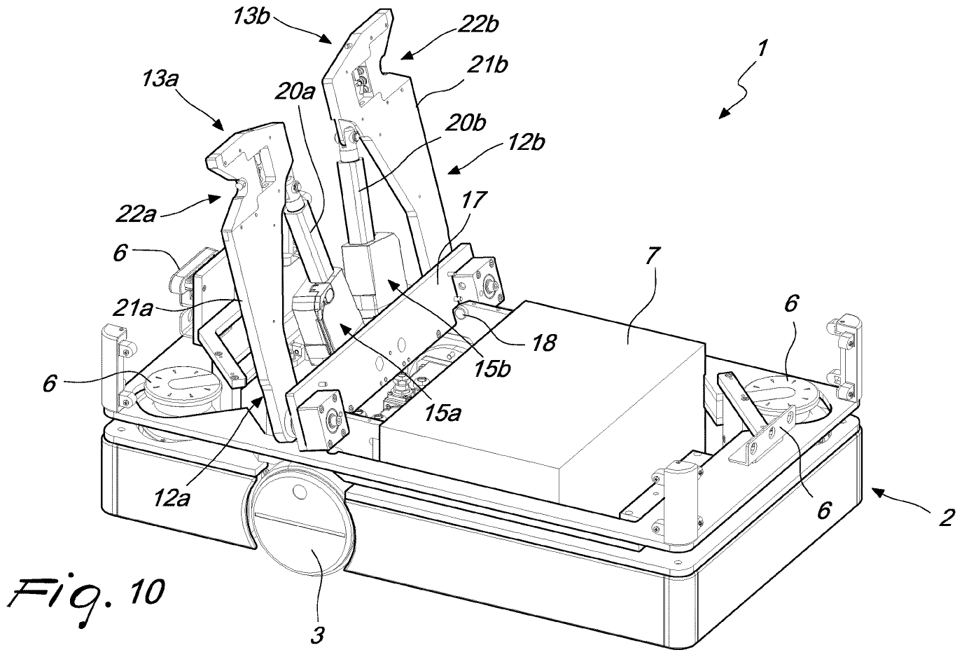

FIG. 10 is a view of the mobile robot in which the cover has been removed and the arms have been made to swing.

In the embodiments that follow, individual characteristics, given in relation to specific examples, may actually be interchanged with other different characteristics that exist in other embodiments.

Moreover, it is noted that anything found to be already known during the patenting process is understood not to be claimed and to be the subject of a disclaimer.

With reference to the figures, an autonomous mobile robot of the type comprising a supporting frame 2 for driving wheels 3 and/or castors 4 coupled to adapted activation means, such as one or more motors 5, has been designated by the reference numeral 1.

Moreover, sensors 6 adapted to generate a proximity scan for the guidance of said mobile robot are associated with the frame 2.

The frame 2 has a substantially parallelepiped and box-like shape which accommodates a rechargeable battery 7, a protective cover 8 being superimposable on said frame 2.

Two arms 12a, 12b are pivoted at the longitudinal sides of the frame 2, at a first end 10a, 10b, by means of adapted first pivots 11a, 11b, and thus lie on a horizontal plane and have a length that keeps them, at rest, within the perimeter of the frame 2 and such a width as to allow them to remain, at rest, within the perimeter of the frame 2 and be able to move apart toward the outside of the frame 2.

Each arm 12a, 12b has a substantially L-shaped configuration in plan view, so as to form a second end 13a, 13b, and said ends are mutually opposite and oriented toward the inside of the frame 2.

Adapted openings 14 are provided at the cover 8 and are adapted to allow the exit, through them, of the second ends 13a, 13b in the parted condition of said arms 12a, 12b.

The parting of the arms 12a, 12b is allowed by electrically actuated linear actuators 15a, 15b, the body 16a, 16b thereof is pivoted to a bar 17 which is arranged transversely to said frame 2 and is in turn associated with the ends by means of second pivots 18.

Such bar 17 can swing manually.

The stem 20a, 20b of the actuators 15a, 15b is pivoted at the second ends 13a, 13b.

Substantially V-shaped conical recesses 22a, 22b are provided at the perimetric edge 21a, 21b of the arms 12a, 12b that is opposite to the second end 13a, 13b and are adapted to affect respective pins 23 which are removably insertable within adapted seats provided in a bottom 24 of an overlying trolley 25 which can move on idle wheels 26.

The trolley 2 has a height from the ground that is greater than that of the mobile robot 1 and the pins 23 protrude, once the mobile robot 1 and the trolley 25 are mutually coupled, in a region which is external to the perimeter of the mobile robot 1 in order to be affected by the conical recesses 22a, 22b once they are parted.

The mobile robot 1 can be positioned under the trolley 25 or under apparatuses provided with a battery charging system, such as a docking station 27 constituted by a base 28 having a substantially rectangular plan shape similar to the bottom 24 of the trolley 25 and from the corners of which adapted legs 34 with end feet 35 protrude toward the ground.

Moreover, at least two connectors 29 protrude from the base 28 in a downward region and a charging power supply can be positioned in an upward region.

The docking station 27 has a height from the ground that is greater than that of the mobile robot 1 and the connectors 29 protrude, once the robot 1 and the docking station 27 are mutually coupled, into a region which is external to the perimeter of the mobile robot 1 in order to be affected by the conical recesses 22a, 22b once they are parted.

Inductive proximity sensors 30 are associated with the conical recesses 22a, 22b and detect the position of an electrical contact shaft 31 when it affects the pins 23 or the connectors 29 and is pushed inward, counteracting a spring 32 that pushes it outward, ensuring effective surface contact.

The shafts 31 are connected to the terminals of the battery 7.

The through shaft 31 is thus forced to protrude, at rest, from the apex of each of the conical recesses 22a, 22b.

The terminal end of the shaft 31 connects electrically to adapted bushings 33 associated with the pins 23 and connectors 29 so that electric power is delivered to the trolley 25 or drawn from the docking station 27.

Moreover, the mobile robot 1 allows to overturn the two arms 12a, 12b, since they are associated with the bar 17, so as to allow to insert or remove the battery 7.

Advantageously, the conical recesses 22a, 22b are lined with self-lubricated plastic material in order to reduce friction.

The operation of the mobile robot is as follows: once the mobile robot 1 has been placed under the trolley 25 or the docking station 27, the two arms 12a, 12b are parted by the electrically controlled linear actuators 15a, 15b while the conical recesses 22a, 22b respectively affect two pins 23 that protrude from the bottom 24 of the trolley 25 or two connectors 29 that protrude from the base 28 of the charging station 27 and self-center.

The opening of the two arms 12a, 12b continues until complete mechanical coupling and electrical contact is achieved.

In the case of the trolley 25, the shaft 31 is pushed by the spring 32 onto the bushing 33 to ensure effective contact.

The inductive proximity sensors 30, in the position for contact of the shaft 31 with the bushing 33, allow the mobile robot to either supply power toward the trolley 25 or to receive power from the charging station 27.

If the battery 7 is completely discharged, the electric actuators 15a, 15b of the two arms 12a, 12b remain blocked; in this case, a two-pole power outlet, to be manually connected to the docking station 27, is provided.

It has thus been found that the invention has achieved the intended aim and objects, an autonomous mobile robot having been obtained which allows both to power a trolley and to power itself from a docking station quickly and easily.

Moreover, the autonomous mobile robot can be optimally powered regardless of whether there is dirt on the ground and preventing the possibility of any impacts or trampling during power supply.

The autonomous mobile robot thus provided operates while coupled to a trolley even regardless of the state of charge of the electronic systems on board the latter, is structurally simple and has low provision and maintenance costs.

Of course, the materials used, as well as the dimensions constituting the individual components of the invention, may be more pertinent according to the specific requirements.

Features indicated as advantageous, appropriate or similar may also be missing or replaced by equivalents.

The disclosures in Italian Patent Application No. 102023000007173 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-9. (canceled)

10. An autonomous mobile robot mechanically connectable to a docking station, or to a trolley provided with electrical apparatuses, comprising two arms, which are configured to be moved mutually apart on a horizontal plane and swing on a vertical plane for accessibility to a battery, on which there are conical recesses provided with means adapted to affect pins/connectors that protrude from a bottom and a base of said docking station or trolley equipped with electrical apparatuses and that are adapted to transmit electric power to said trolley or to receive electric power from said docking station.

11. The autonomous mobile robot according to claim 10, further comprising a frame for supporting driving wheels and/or castors coupled to activation means, such as one or more motors, with which sensors adapted to generate a proximity scan for guiding said mobile robot are associated in front and rear regions, said frame having a substantially parallelepiped and box-like shape which accommodates a rechargeable battery, a cover being superimposable on said frame, the two arms being pivoted at longitudinal sides of said frame, at a first end, by means of first pivots, which lie on a horizontal plane and have a length that keeps said pivots, at rest, within the perimeter of said frame and a width such as to enable said pivots to remain, at rest, within the perimeter of said frame and to be moved mutually apart toward an outside of said frame, each of said two arms having a substantially L-shaped plan configuration so as to form a second end, said first and second ends being arranged mutually opposite and oriented toward an inside of said frame, said two arms being configured to swing on a vertical plane with respect to said frame to allow access to said battery.

12. The autonomous mobile robot according to claim 11, wherein at said cover there are openings which are adapted to allow exit, through them, of said second ends in the mutually apart condition for said arms, the parting of said arms being allowed by electrically actuated linear actuators, a body of which is pivoted to a bar which is arranged transversely to said frame and in turn associated with it at ends thereof by means of second pivots, said bar being manually swingable, a stem of said actuators being pivoted at said second ends.

13. The autonomous mobile robot according to claim 11, wherein at a perimetric edge of said two arms that is opposite to said second end there are substantially V-shaped conical recesses adapted to affect respective pins which can be removably inserted within seats formed on a bottom of said overlying trolley which can move on idle wheels, said trolley having a height from the ground that is greater than that of said mobile robot, said pins protruding, once said mobile robot and said trolley are coupled together, into a region outside the perimeter of said mobile robot to be affected by said conical recess once they have moved mutually apart, said means adapted to affect said pins/connectors being associated with said conical recesses.

14. The autonomous mobile robot according to claim 10, wherein said means adapted to affect said pins/connectors are constituted by inductive proximity sensors that detect a position of an electrical contact shaft when the electrical contact shaft affects said pins or said connectors and is pushed inward, counteracting a spring that pushes the electrical contact shaft outward, ensuring effective surface contact.

15. The autonomous mobile robot according to claim 10, configured to be positioned below said trolley or said docking station constituted by said base having a substantially rectangular plan shape that is analogous to said bottom of said trolley.

16. The autonomous mobile robot according to claim 10, wherein legs with end feet protrude toward the ground from corners of said base, at least two connectors protruding from said base in a lower region and a charging power supply being arrangeable in an upper region, said docking station having a height above the ground that is greater than that of said mobile robot and said connectors protruding, once said mobile robot and said docking station are mutually coupled, in a region that is external to a perimeter of said mobile robot in order to be affected by said conical recesses once the mobile robot and the docking station are moved mutually apart.

17. The autonomous mobile robot according to claim 14, wherein said electrical contact shaft is connected to the terminals of said battery by means of electrical cables, said shaft being preloaded by said spring, which ensures effective electrical contact.

18. The autonomous mobile robot according to claim 14, wherein an end of said electrical contact shaft connects electrically to bushings associated with said pins and connectors so that electric power is delivered to said trolley or electric power is drawn from said docking station.
